(19) United States
(12) Patent Application Publication
(10) Pub. No.: US 2014/0012406 A1
(43) Pub. Date: Jan. 9, 2014

(54) Rapid Manufacturing Customization Of Footwear Components

(71) Applicants: Bryan P. Cioffi, Glouscester, MA (US); Pamela S. Greene, Portland, OR (US); Sean M. McDowell, Portland, OR (US)

(72) Inventors: Bryan P. Cioffi, Glouscester, MA (US); Pamela S. Greene, Portland, OR (US); Sean M. McDowell, Portland, OR (US)

(73) Assignee: Nike, Inc., Beaverton, OR (US)

(21) Appl. No.: 13/542,067

(22) Filed: Jul. 5, 2012

(51) Int. Cl. G06F 19/00

(52) U.S. Cl. 700/118

(57) ABSTRACT

Aspects of the present invention relate to methods and systems for rapid manufacturing (RM) customization of footwear components. An order is received in a retail facility for the custom footwear component comprising one or more embellishments selected by a customer. The order is converted into RM instructions. An RM device receives the customization instructions and manufactures the one or more embellishments.

### BACKGROUND

The basic structure surrounding the manufacture and retail of apparel (e.g., clothing, articles of footwear, accessories, and the like) has changed little over the past several decades. Under this structure, a piece of apparel is produced in one location and sold in another. These two locations are removed from each other and rarely interact beyond shipping products therebetween. For instance, shoes are typically designed and built to completion prior to being shipped to a retail facility (e.g., shoe store). As such, potential customers are offered a limited selection of shoe designs at the retail facility, even when the tastes of the potential customers may vary dramatically. As such, employing emerging technologies, such as rapid manufacturing would allow buyer-selected three-dimensional (3D) designs to customize apparel within a retail facility (e.g., shoe store) and would enhance the potential customer's experience when shopping for and selecting the apparel.

### SUMMARY

Aspects of the present invention relate to rapid manufacturing (RM) customization of footwear components to improve a customer's retail experience by allowing the customer to select and customize an article of footwear within a retail facility (e.g., shoe store). Customizing the article of footwear might include, for instance, selecting a three-dimensional (3D) design or functional pattern (collectively, “embellishments”) to be rapidly manufactured and applied to the article of footwear in the retail facility. The embellishment is selected from a catalog of predefined images (e.g., logos, symbols, team emblems, and the like) and/or words (e.g., names of people, brand names, expressions, dates, and the like), submitted by the customer in a digital format, or drawn on a computing device/tablet device within the context of the retail facility. If the embellishment is selected from a catalog, a barcode or item code corresponding to the embellishment is scanned or input by an operator, typically behind a sales counter, and an order for the customized article of footwear is established. After the order is received by a computing device, RM instructions are provided to an RM device. The RM device, in turn, manufactures the embellishment. The embellishment is then applied to the article of footwear. Upon completion of the order within the retail facility, the customized article of footwear is presented to the customer at the sales counter. As such, aspects of the present invention allow a customer to enter the retail facility, place an order to customize an article of footwear, or any other piece of apparel, and obtain the customized article of footwear in a matter of minutes from the initial entry, where the customized article of footwear is in a ready-to-wear condition.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative aspects of the present invention are described in detail below with reference to the attached drawing figures, which are incorporated by reference herein and wherein:

FIG. 1 depicts a block diagram of an exemplary system architecture suitable for use in implementing aspects of the present invention;

FIG. 2 depicts a medial side view of an article of footwear having a predetermined location to receive a custom footwear component, in accordance with aspects of the present invention;

FIGS. 3A-3B depicts top and cross-sectional views, respectively, of a custom footwear component, in accordance with aspects of the present invention;

FIGS. 4A-9B depicts perspective and cross-sectional views of various relief heights for custom footwear components, in accordance with aspects of the present invention;

FIG. 10 depicts a medial side view of an article of footwear having a predetermined location to receive a custom footwear component, in accordance with aspects of the present invention;

FIGS. 11A-13B depict medial side views of various functional patterns for custom footwear components, in accordance with aspects of the present invention;

FIGS. 14A-14B depict medial side views of articles of footwear and various functional patterns for custom footwear components, in accordance with aspects of the present invention;

FIGS. 15A-15C depict medial side and cross-sectional views of articles of footwear and various functional patterns for custom footwear components, in accordance with aspects of the present invention;

FIG. 16 illustrates a flow diagram showing a method of manufacturing custom footwear components, in accordance with aspects of the present invention; and

FIG. 17 illustrates a flow diagram showing a method of incorporating custom footwear components into articles of footwear, in accordance with aspects of the present invention.

### DETAILED DESCRIPTION

The subject matter of aspects of the present invention is described with specificity herein to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present invention generally relate to enhancing a potential customer's retail experience when selecting and purchasing a piece of apparel. More particularly, aspects of the present invention relate to on-site customization of an article of footwear based on the potential customer's preferences.

In one aspect, the present invention relates to a system for manufacturing a custom footwear component in a retail facility. Initially, the system includes an input device configured to receive an order for the custom footwear component. The custom footwear component comprises one or more embellishments selected by a customer. A computing device is configured to receive the order from the input device and convert the order into rapid manufacturing (RM) instructions. An RM device receives the RM instructions from the computing device and manufactures the one or more embellishments.

In another aspect, the present invention relates to a method of incorporating a custom footwear component comprising one or more embellishments into an article of footwear.

An order is received at an order interface rendered by a computing device. The order includes specifications that pertain to the one or more embellishments. The specifications of the order are converted into RM instructions. The RM instructions are communicated to an RM device. The RM instructions are executed by the RM device to manufacture the one or more embellishments. The one or more embellishments are applied to the article of footwear.

In yet another aspect, the present invention relates to a method of manufacturing custom footwear components. An order for one or more embellishments is received in a retail facility. The one or more embellishments comprise a three-dimensional description of one or more customizations, predetermined designs, functional patterns, or any combination thereof. The one or more embellishments further include embellishment options. The options comprise at least one of size, color, and relief height. The specifications of the order are converted into RM instructions. The RM instructions are communicated to and executed by an RM device, at the retail facility. The RM device manufactures powder sintered custom footwear components that resemble the received order.

Having briefly described an overview of aspects of the present invention, an exemplary operating environment suitable for implementing aspects of the present invention is described below.

As used herein, the phrase “retail facility” is not meant to be limiting, but may encompass a wide range of accommodations for housing the equipment necessary for RM customization of footwear components. The retail facility may be a store, a stand-alone structure, a room that shares at least one wall with another room, a private residence, a public area, a moveable unit, etc. By way of example, the retail facility may be a vehicle that travels to sporting events or concerts, which is capable of customizing footwear components with designs that are relevant to the venue where the vehicle is presently located.

As used herein, the term “embellishments” generally refers to a three-dimensional visual or functional impression, such as designs, patches, inserts, decorative components, name tags, dates, pouches, lace holders, snap fittings, mounts for accessories, functional patterns, logos, multi-color images (e.g., high school mascots), monotone images, symbols (e.g., representing a holiday, season, or special day of the year), indicia of an organization (e.g., private company, charity, or social group), text, phrases in one or more languages, expressions, names, team emblems, strings of alpha-numeric characters, ornamentation, decoration, diagrams, pictures, photos, markings, or any combination thereof. By way of example, a single embellishment may be a number donned by a famous athlete in conjunction with the name of the athlete above or below the number. The embellishment may also serve a functional purpose such as providing stability or support in a particular area of the footwear that is customized for a particular person.

One particular process for forming the embellishments in accordance with aspects described herein is laser sintering. This process involves receiving a three-dimensional design or description of the embellishment in a data file (i.e., a Computer Aided Design (CAD) file). The rapid manufacturing (RM) device, such as a laser sintering fabrication equipment, reads the data file and forms the three-dimensional object of the design, such as a name tag, logo, or functional structure for application to an article of footwear, using a high powered laser to fuse powders or small particles of plastic, metal, or ceramic. The laser selectively fuses powdered material by scanning cross-sections generated from the data file or a scan of the part on the surface of a powder bed. After each cross-section is scanned, the powder bed is lowered by one layer thickness, a new layer of material is applied on top, and the process is repeated until the part is completed. As can be appreciated, any rapid manufacturing process can be utilized to achieve RM customization of footwear components in accordance with aspects of the present invention.

The use of RM customization of footwear components is significantly less expensive than whole shoe or whole footbed RM products. Accordingly, the price point is realistic for casual consumers. For example, whole shoe RM products may include large parts that take up a lot of volume in the RM build chamber and make each batch inefficient in packing the build density of the build chamber. Benefits of RM customization of footwear components include reasonable prices for smaller parts. Further, batch to batch variability is much less important for components compared to whole shoe or whole footbed RM products. Still further, components are flatter and smaller parts, which make them much stronger than whole shoe or whole footbed RM products because the components are generally flat parts that can be built horizontally, rather than the x, y, and z axis build utilized for whole shoe or whole footbed RM products. In addition, building the components in a horizontal plan makes the build in the chamber more efficient. Since the build chamber is filled more efficiently, components are cheaper to produce. RM customization of footwear components does not require molds needed to create parts or an inventory of parts, allowing custom shapes and colors to be created on demand. Application of components into predetermined areas eliminates the potentially problematic issues associated with fatigue and break in whole shoe or whole footbed RM products. The components can be applied in low stress zones and locations that increase comfort. Components also do not require the need for scanning time, allowing a consumer to select from an estimated fit menu. Retail stores could have try-on samples, allowing a consumer to try prebuilt examples with options already assembled in the consumer's size to select the component that meets that consumer's preferences.

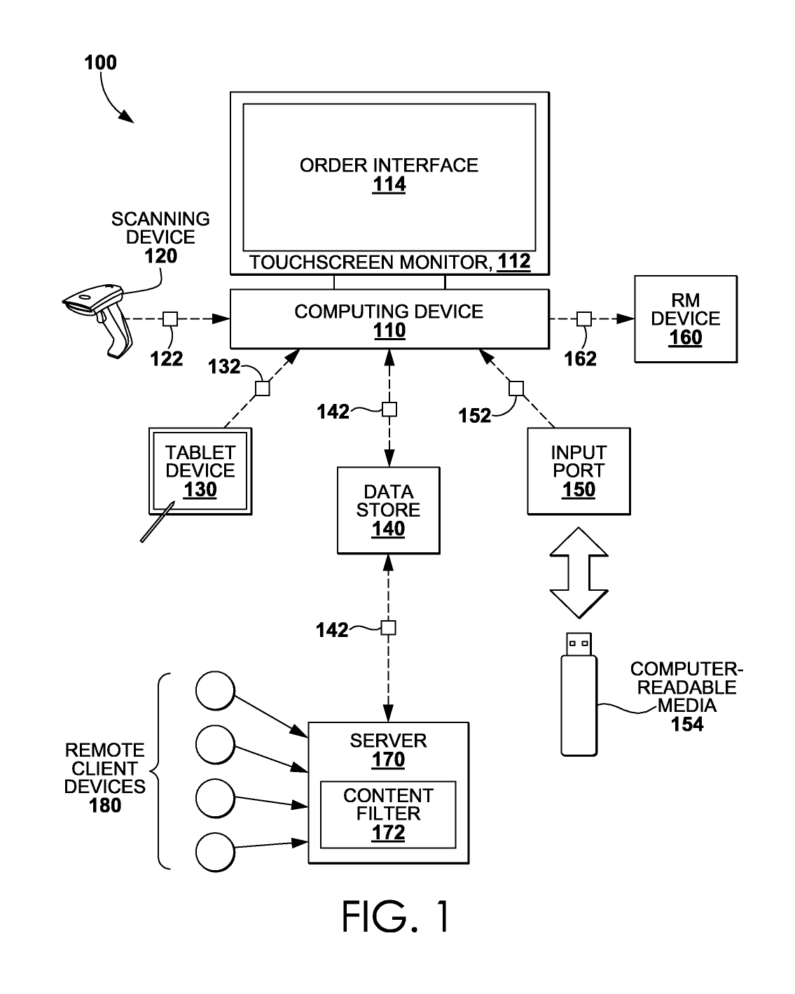

Turning to FIG. 1, a block diagram is shown that illustrates an exemplary system architecture 100 suitable for use in implementing aspects of the present invention. Initially, the system architecture 100 includes a computing device 110 communicatively coupled to a touchscreen monitor 112, a scanning device or data entry device 120, a tablet device 130, a data store 140, an input port 150 that can accept and read computer-storage media 154, an RM device 160, and a server 170 reachable by remote client devices 180. This exemplary system architecture 100 is but one example of a suitable environment that may be implemented to carry out aspects of the present invention, and is not intended to suggest any limitation as to the scope of use or functionality of the invention. Neither should the illustrated exemplary system architecture 100 be interpreted as having any dependency or requirement relating to any one or combination of the components 110, 112, 120, 130, 140, 150, 154, 160, 170, and 180 as illustrated. It will be understood and appreciated that the components 110, 112, 120, 130, 140, 150, 154, 160, 170, and 180 illustrated in FIG. 1 are exemplary in nature and in number and should not be construed as limiting. Accordingly, any number of components may be employed to achieve the desired functionality within the scope of aspects of the present invention.

Further, the components of the exemplary system architecture 100 may be interconnected by any method known in the relevant field. For instance, the computing device 110, the touchscreen monitor 112, the scanning device 120, the tablet device 130, the data store 140, the input port 150, the RM device 160, and the server 170 may be operably coupled via a distributed computing environment that includes multiple computing devices coupled with one another via one or more networks. In aspects, a touchless gesture device is used in place of, or in addition to, the touchscreen monitor 112. In aspects, the network (not shown) may include, without limitation, one or more local area networks (LANs) and/or wide area networks (WANs). Such networking environments are commonplace in offices, businesses, enterprise-wide computer networks, intranets, and the Internet. Accordingly, the network is not further described herein.

The computing device 110, the scanning device 120, the tablet device 130, the server 170, and the remote client devices 180 shown in FIG. 1 may take the form of various types of computing devices that have at least one processor in communication with memory. By way of example only and not limitation, each of the computing device 110, the scanning device 120, the tablet device 130, the server 170, and the remote client devices 180 may be a personal computer, desktop computer, laptop computer, handheld device, consumer electronic device, handheld device (e.g., personal digital assistant), various servers, and the like. It should be noted, however, that the invention is not limited to implementation on such computing devices, but may be implemented on any of a variety of different types of computing devices within the scope of aspects of the present invention.

The touchscreen monitor 112 is communicatively coupled to the computing device 110 and is capable of presenting an order interface 114 rendered by the computing device 110. In other aspects, the touchscreen monitor 112 is configured to render and/or present a user-interface (UI) display thereon for displaying other information, such as a purchasing screen. Generally, the touchscreen monitor 112 may be configured as any presentation component that is capable of presenting information to a user, such as a digital monitor, electronic display panel, touch-screen, analog set top box, plasma screen, and the like. In one exemplary aspect, the touchscreen monitor 112 is configured to present graphical content, such as a UI display that includes a display area populated with representations of an embellishment and an article of footwear.

The data store 140 is generally configured to store information associated with user-submitted orders and/or specifications included therein. In various aspects, such information may include, predefined embellishments selectable by a customer, customer-provided embellishments submitted by a customer, RM instructions 162 associated with embellishments, and the like. In addition, the data store 140 may be configured to be searchable for suitable access of the stored information. For instance, the data store 140 may be searchable by the computing device 110 when rendering the order interface 114 or when converting the order into the RM instructions 162. The content and volume of such information are not intended to limit the scope of aspects of the present invention in any way. Further, though illustrated as a single, independent component, the data store 140 may, in fact, be a plurality of databases.

In operation, an input device initially receives an order for a custom footwear component comprising one or more embellishments selected by a customer from one or more mechanisms. After the order is received by the input device, a computing device 110 is configured to receive the order from the input device. In one aspect, the scanning device 120 is configured to scan and communicate a barcode or item code 122 to the computing device 110, where the barcode is associated with an embellishment that is predefined and published in a catalog (e.g., digital catalog, print catalog, three-dimensional sample book, or display products for trial fitting). The barcode may additionally contain a code to identify a location, an orientation, and an application type for application of the embellishment. For example the location could specify that the embellishment should be applied to the quarters, the tongue top, or heel. In another aspect, the input port 150, which is operably connected to the computing device 110, receives and reads the computer-readable media 154 provided by the customer, where one or more customer-provided embellishments 152 reside on the computer-readable media 154. By way of example, and not limitation, the computer-readable media 154 may comprise flash memory, Random Access Memory (RAM), Read Only Memory (ROM), Electronically Erasable Programmable Read Only Memory (EEPROM), CDROM, digital versatile disks (DVDs) or other optical or holographic media, magnetic cassettes, magnetic tape, magnetic disk storage or other magnetic storage devices, or any other medium that can be used to encode desired information and be accessed by computing device 110.

In another aspect, the computing device 110 receives the embellishment to be incorporated in the order from a tablet device 130. Typically, the tablet device 130 is operably connected to the computing device 110 and is configured allow an operator to draw one or more original embellishments 132 thereon. Once the original embellishments 132 are drawn, they can then be transmitted to the computing device 110 for incorporation into the order. Or, the tablet device 130 may be configured to trace a tangible image provided by the customer, wherein the traced image is communicated to the computing device 110 as the embellishment to be incorporated into the order. In an exemplary aspect, a tangible physical object (e.g., a face) is scanned by a scanning device (not shown in FIG. 1) operably connected to the computing device 110, in one aspect, and translated by the computing device 110 into a component (e.g., a cameo silhouette of a face) for incorporation into the order.

In yet another aspect, the server 170 receives orders entered by customers at a web site hosted by the server 170. The customers may reach the web site via the remote client devices 180 and select embellishments within an order interface supported by the web site. In particular instances, the order interface supported by the web site is configured to render options related to shoe sizes and models, to present a display area for locating one or more selected embellishments relative to an article of footwear, and to identify selections of the options made by the customer. Upon the customer entering the order at the order interface within the web site hosted by the server 170, the server 170 may distribute the order to the computing device 110 at the retail facility that is selected by the customer, or most proximate to a residence/workplace of the customer.

In one aspect, the order interface supported by the web site accepts customer-provided embellishments 142. When the server 170 identifies that the customer-provided embellishments 142 are entered at the order interface, a content filter 172 may be invoked to ensure that the customer-provided embellishments 142 do not contain offensive material, indicia of competitors, or obscene subject matter. If the customer-provided embellishments 142 satisfy the content filter 172, the server 170 is further configured send the customer-provided embellishments 142 to the data store 140 that persists the customer-provided embellishments 142 for pre-defined timeframe before allowing the computing device 110 to access and process the customer-provided embellishments 142. Securing the customer-provided embellishments 142 in the data store 140 for the pre-defined timeframe allows for additional automated or manual review of the customer-provided embellishments 142 to ensure no issues may arise if the customer-provided embellishments 142 are affixed on a piece of apparel that also bears a logo or name of the customization company.

After the order is received by any of the input devices, scanning device 120, tablet device 130, server 170, or input port 150, described herein, computing device 110 is configured to receive the order from the input device. In one aspect, the order is customized to fit a particular shoe size. In another aspect, the order includes patterns, graphics, and coloration selected by a customer for the one or more embellishments. The order is then converted into RM instructions. An RM device in communication with the computing device is configured to receive the RM instructions from the computing device and manufacture the one or more embellishments.

In operation, the computing device receives one or more embellishments from the input device. In one aspect, the one or more embellishments are scaled on demand, requiring no molds or parts inventory. In one aspect the one or more embellishments comprise patches, inserts, decorative components, name tags, logos, dates, pouches, lace holders, snap fittings, mounts for accessories, or any combination thereof. In another aspect the one or more embellishments comprise customizations, predetermined designs, functional patterns, or any combination thereof. In one aspect, the functional patterns comprise fit enhancing, breathable, strengthening, protective, flexible, adaptive, and/or wear-resistant designs. In another aspect, the printing of electrically conductive elements within an RM embellishment is chosen for the purposes of creating conductivity to enable digital components including but not limited to light emitting or message displaying components to be secured to the footwear or garment. A three-dimensional design or description of the one or more embellishments in converted into a data file is communicated to the RM device.

The RM device, such as a laser sintering fabrication equipment, reads the data file and forms the three-dimensional object of the design. Once the design has been formed, the RM device uses a high powered laser to fuse powders or small particles of plastic, metal, or ceramic. The laser selectively fuses powdered material by scanning cross-sections generated from the data file or a scan of the embellishment on the surface of a powder bed. After each cross-section is scanned, the powder bed is lowered by one layer thickness, a new layer of material is applied on top, and the process is repeated until the one or more embellishments are completed.

Additionally, it is contemplated that one or more identifiers may be applied to one or more embellishments. For example, when two or more embellishments are manufactured in a common RM build chamber, an identifier (e.g., order number, part number, name) associated with each of the concurrently manufactured embellishments may aid in providing the proper article to the ordering entity. Additionally, it is contemplated that one or more registration-type indicators may be incorporated into an embellishment. For example, an orientation indicator that indicates a proper orientation of an embellishment relative to a target location may be manufactured into the embellishment by the RM device. Registration markings may include vertical and horizontal line indicators place on the embellishment in locations that will not be visible once coupled with a target region, such as a back surface. The insertion of an identifier, a registration mark, and other functional indicators may be done by a user, a computing device, a software program/module, a RM device, and/or the like.

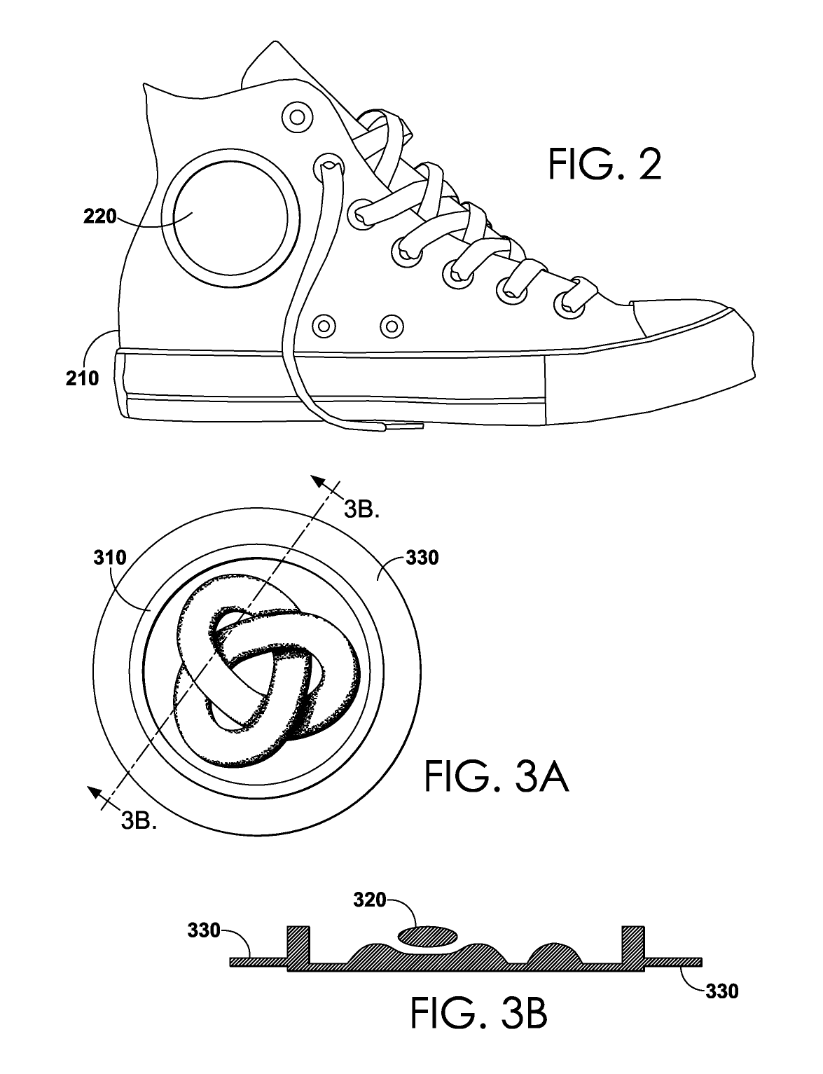

Referring now to FIG. 2, a medial side view of an article of footwear having a predetermined location to receive a custom footwear component is shown, in accordance with aspects of the present invention. In one aspect, an application device applies the one or more completed embellishments to a location 220 on an article of footwear 210. In one aspect, the location 220 is a predetermined location designed to receive the one or more embellishments. For example, the predetermined location 220 may be in a low stress zone which may eliminate or reduce the risk of the embellishment bending or breaking. In another example, the predetermined location 220 may in an area that is likely to increase comfort for the wearer of the article of footwear 210 (i.e., ankle impact protection, better fit for wide ankles, to accommodate large malleolus bones, improve ankle support, extend the heel area in width or length, extend the topline, and/or add strengthening, wear-resistant, or reinforcing components). In another example, the predetermined location 220 may be in an area to effect stretch and flexibility. In another example, the predetermined location 220 may be a window or flange configured to receive an embellishment.

Referring now to FIG. 3A-3B, top and cross-sectional views of a custom footwear component are shown, in accordance with aspects of the present invention. In one aspect, the one or more embellishments 310 include an attachment flange 330. The attachment flange 330 allows the one or more embellishments 310 to be applied to the article of footwear. In one aspect, a mechanism such as a receptacle or fitting is designed to interface with a receptacle on the article of footwear. Free-floating areas 320 of the design are included, in some aspects, as depicted in FIG. 3B. Additive manufacturing makes free-floating design possible, whereas, by conventional means, it may not possible to mold such intricate designs.

In one aspect, applying the one or more embellishments comprises pressing and/or inserting the one or more embellishments to the location. In another aspect, applying the one or more embellishments comprises heat welding the one or more embellishments to the location. In another aspect, applying the one or more embellishments comprises radio frequency welding the one or more embellishments to the location. In another aspect, applying the one or more embellishments comprises sonic welding the one or more embellishments to the location. In yet another aspect, applying the one or more embellishments comprises computer stitching the one or more embellishments to the location. In one aspect, applying the one or more embellishments comprises inserting the one or more embellishments to the location. In another aspect, applying the one or more embellishments comprises gluing the one or more embellishments to the location. Additional mechanisms for applying the one or more embellishments are contemplated in exemplary aspects.

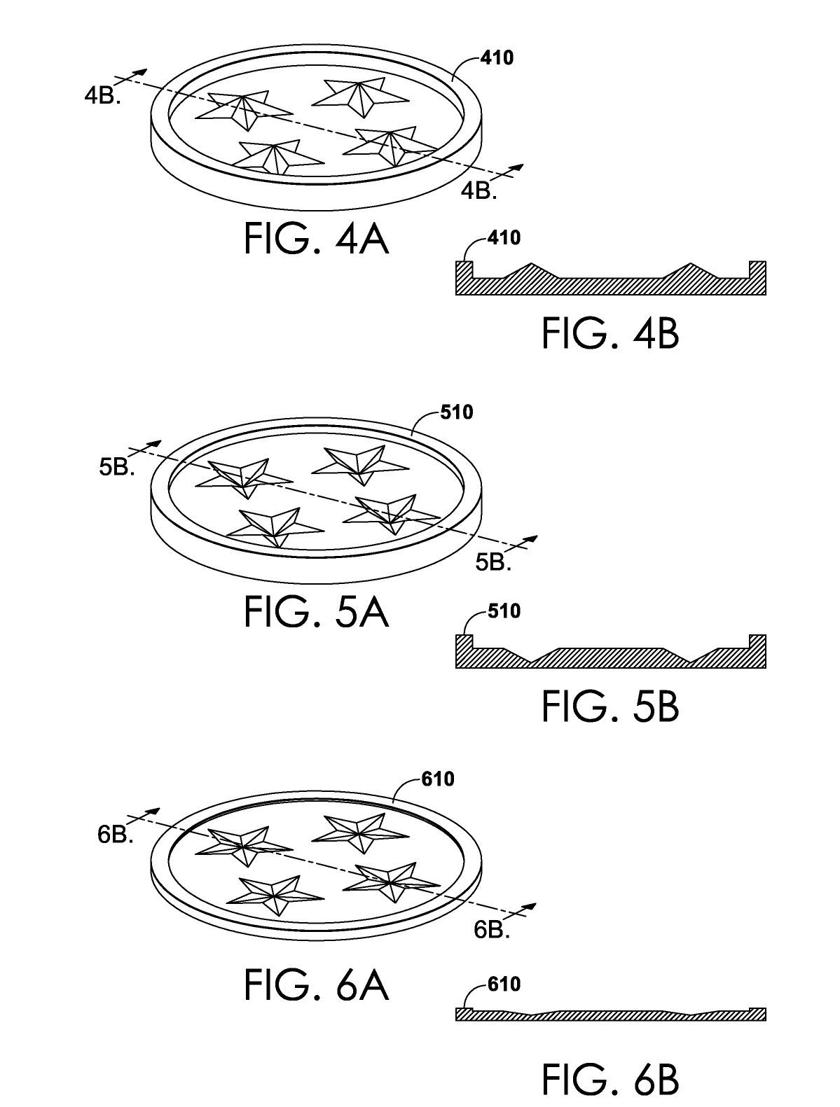

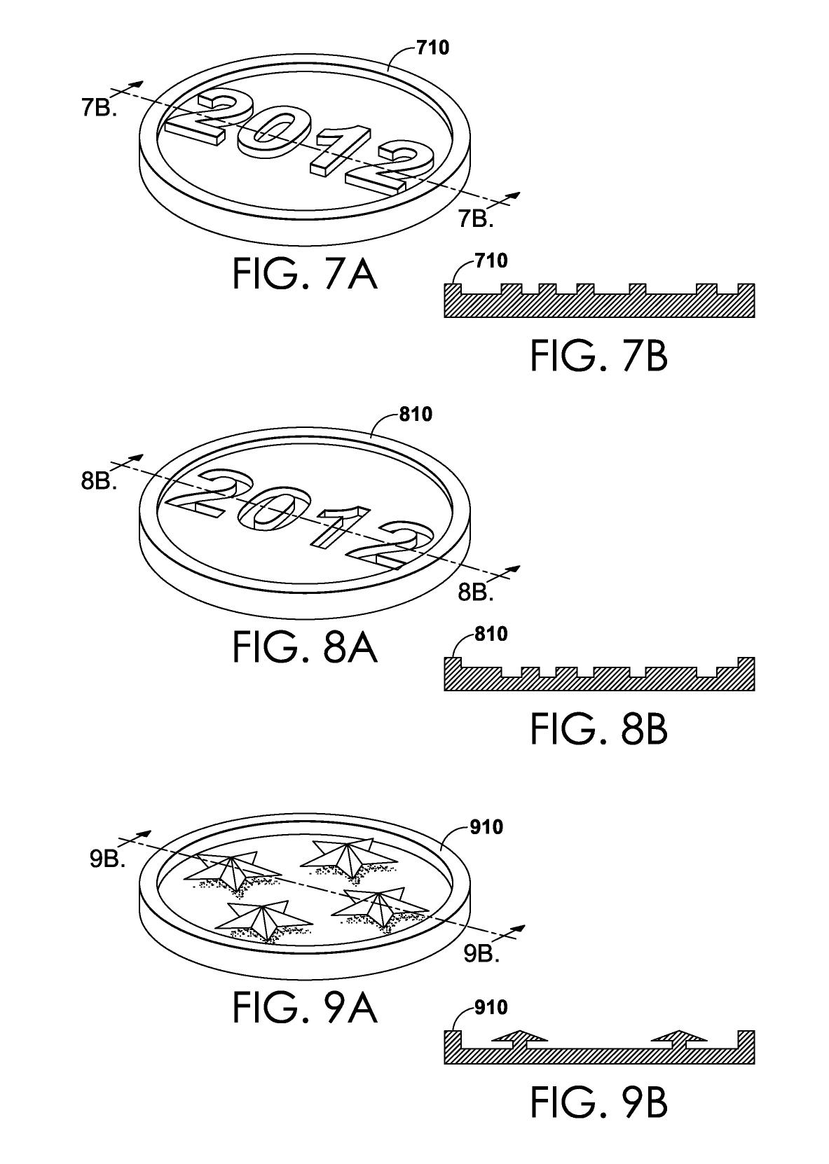

Referring now to FIGS. 4A-9B, perspective and cross-sectional views of various relief heights for custom footwear components are shown, in accordance with aspects of the present invention. In one aspect, various relief heights or relief styles 410, 510, 610, 710, 810, 910 are selected by a customer to achieve the desired 3D effect. The depth and detail, as well as number of location on the product, can be offered to the customer for various costs. For example, a less dimensionally surfaced offering is cheaper to produce since it fills the build chamber more efficiently. Depth options may include high-relief, mid-relief, low-relief, shallow-relief, sunk-relief, and counter-relief intaglio. The high-relief option may include undercut areas, as depicted in FIG. 9B, and more than 50% of the depth is shown. Undercut areas are accomplished with additive manufacturing. In the shallow-relief option, the background material may be removed by little more than scratching the plane. In the counter-relief intaglio option, rather than rising from the background, the form may be cut into it.

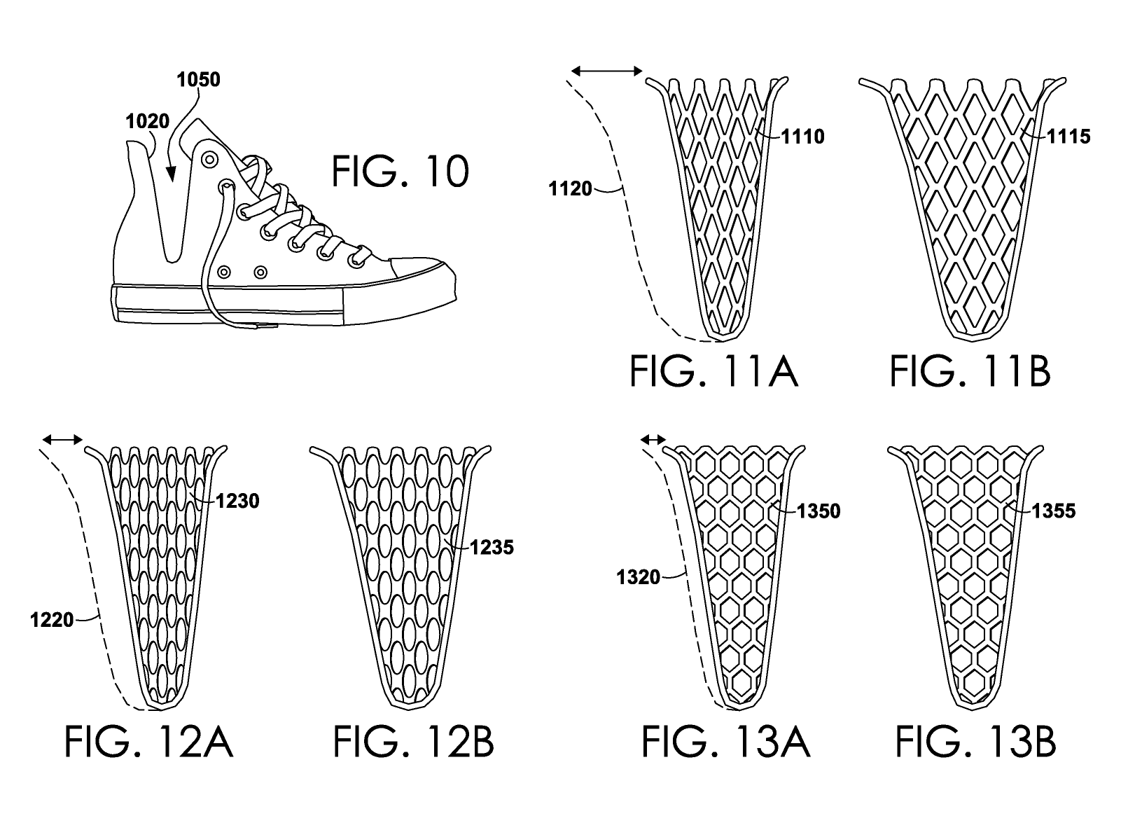

Referring to FIG. 10, a medial side view of an article of footwear having a predetermined location to receive a custom footwear component is shown, in accordance with aspects of the present invention. The one or more embellishments are received for attachments in the collar insert area 1050. A collar insert area may be found on either side of the heel collar 1020 (e.g., one on the lateral side, one on the medial side). It is contemplated that any number, size, and/or location of collar inserts may be incorporated into exemplary aspects

Referring now to FIGS. 11A-13B, medial side views of various functional patterns for custom footwear components are shown, in accordance with aspects of the present invention. In one aspect, various functional patterns 1110, 1230, 1350 are selected to achieve various maximum stretch widths 1115, 1235, 1355, respectively. These functional patterns provide varying degrees of contribution to the fit enhancing, breathability, strengthening, and wear-resistant characteristics of the design. For example, functional pattern 1110 has stretch potential 1120. When functional pattern 1110 is fully stretched to its stretch potential 1120, it reaches maximum stretch width 1115. Similarly, when functional pattern 1230 is fully stretched to its stretch potential 1220, it reaches maximum stretch width 1235. Likewise, when functional pattern 1350 is fully stretched to its stretch potential 1320, it reaches maximum stretch width 1355.

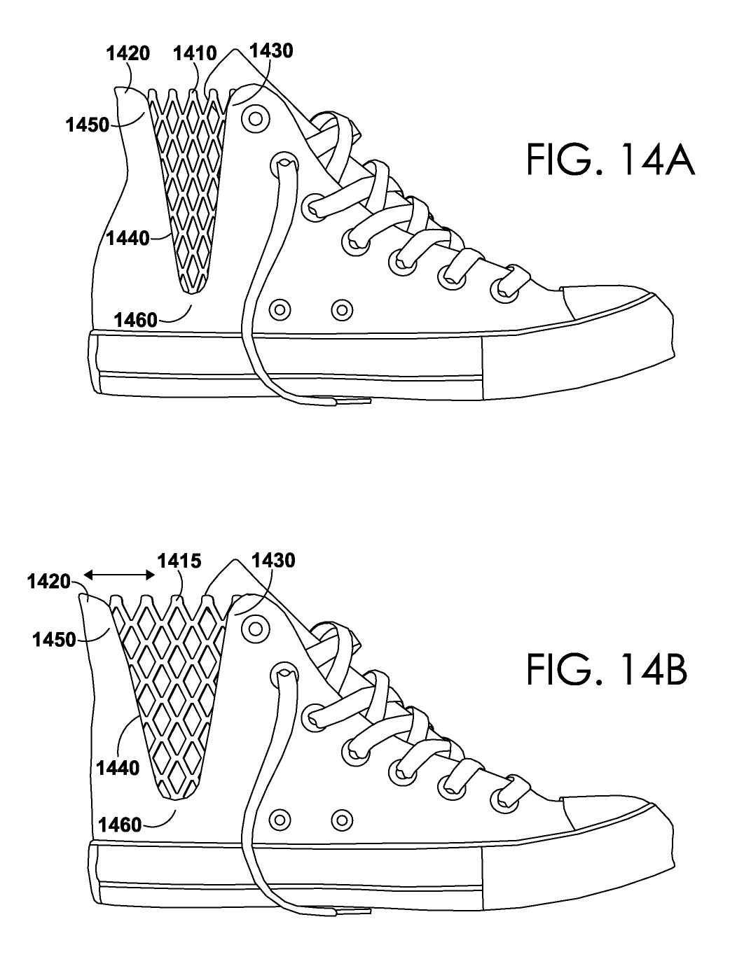

Referring now to FIGS. 14A-14B, medial side views of articles of footwear and various functional patterns for custom footwear components are shown, in accordance with aspects of the present invention. An embellishment 1410, in the form of a functional pattern, is shown attached to the article of footwear illustrated in FIG. 14. FIG. 14A shows the article of footwear in a non-expanded position. As shown in FIG. 14B, when the heel collar requires flexibility, such as when a foot is inserted into the article of footwear, or when the article of footwear is undergoing various types of stresses from wear, embellishment 1410 accommodates this need for flexibility by achieving its maximum stretch width 1415, allowing the heel collar 1420 freedom of movement so the article of footwear is in an expanded position. Such an embellishment accommodates customers with wider ankles, allows easy-on and easy-off removal, or provides better ventilation. Embellishment 1410 is removably coupled, in any manner described herein, to the article of footwear along the collar insert perimeter 1440, the collar insert perimeter 1440 representing a cutout portion of the upper extending downward towards the midsole 1460 from a first portion of the upper 1430 and then upward towards a second portion of the upper 1450 proximate the top of the heel collar 1420.

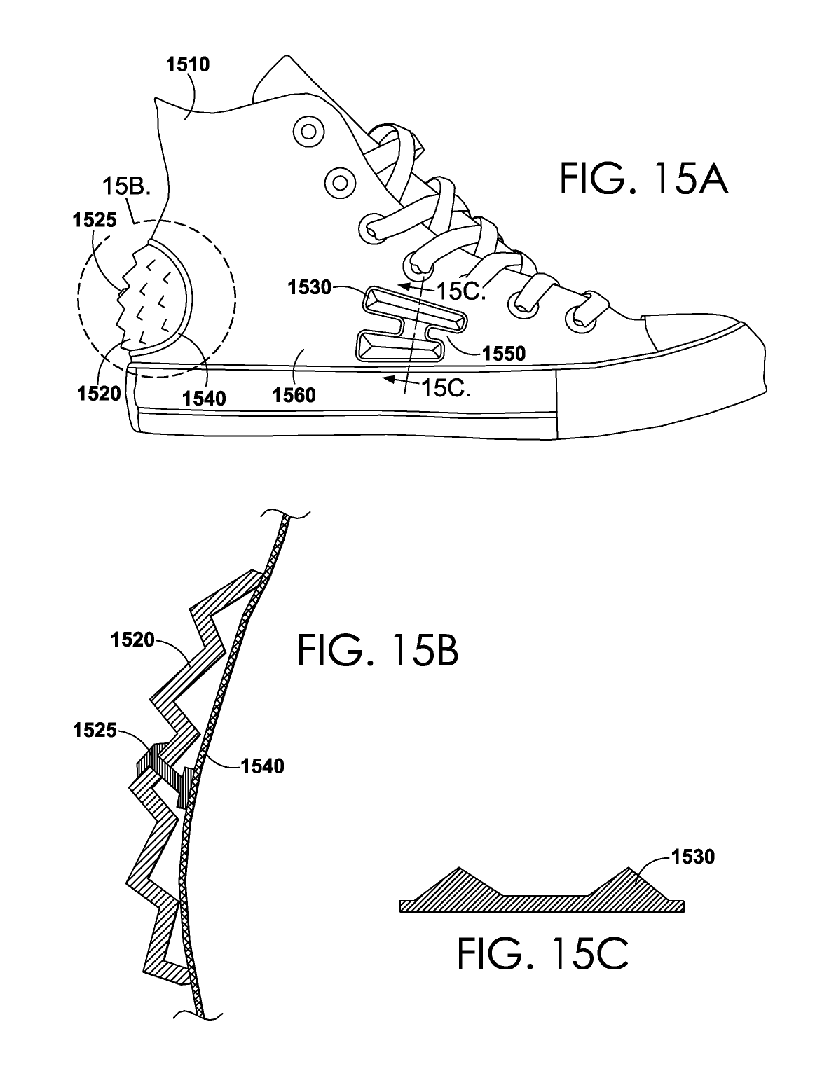

Referring now to FIGS. 15A-15C, medial side and cross-sectional views of articles of footwear and various functional patterns for custom footwear components are shown, in accordance with aspects of the present invention. The article of footwear is shown with embellishments 1520 and 1530 that can extend the durability of an article of footwear utilizing unique wear data that allows for the manufacture of a custom patch or embellishment. For example, the heel abrasion protector, illustrated by embellishment 1520, may provide for better heel wear. Since the heel of the right foot is often in contact with the floorboard of a vehicle while braking or accelerating, the right heel of an article of footwear may wear more rapidly than the left heel of the article of footwear. Accordingly, based on wear zones in the past, or predicted wear zones, a customer may desire to extend the durability in that area that receives habitual contact with surfaces encountered during activities. In this respect, embellishment 1520 is removably coupled, in any manner described herein, to the surface of the article of footwear in the desired area. As illustrated, embellishment 1520 is removably coupled to the surface of the lower heel collar 1540. In one aspect, an attachment hub 1525 is used to couple the embellishment 1520 to the article of footwear. In one aspect, the embellishment 1520 snap fits over the attachment hub 1525. In one aspect, the attachment hub 1525 is pre-existing on the article of footwear. In another aspect, the attachment hub 1525 is added from parts in inventory at the time of embellishment attachment. In another example, someone who frequently bikes may notice that a bicycle pedal causes wear on another portion of the article of footwear. A bike pedal abrasion protector, illustrated by embellishment 1530, may provide for better wear on that portion of the article of footwear. As illustrated, embellishment 1530 is removably coupled to the surface of the lower upper 1550 proximate the midsole 1560. In one aspect, input is received that indicates a location on the article of footwear that needs extended durability protection. It should be appreciated that each customer may experience unique wear zones, and that each customer may need a customized, non-symmetrical embellishment to protect that location. In another aspect, an article of footwear can be repaired utilizing similar custom embellishments to provide for better wear or patch existing areas of wear.

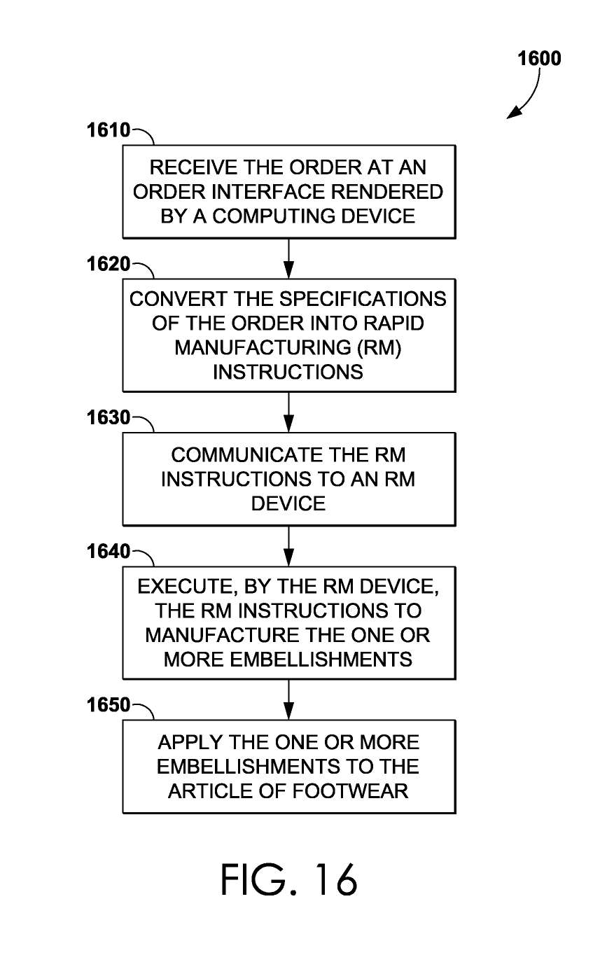

Referring now to FIG. 16, a flow diagram is illustrated that shows an overall method 1600 for manufacturing custom footwear components, in accordance with aspects of the present invention. Initially, as depicted at step 1610, an order is received at an order interface rendered by a computing device. The order includes specifications that pertain to the one or more embellishments. In one aspect, the order interface is linked to a customer-facing pricing algorithm that accounts for a number of parts in the order to be applied to the article of footwear and based upon data comprising at least one of part size, build time, complexity relief height, and location of attachment. As such, a price for a resulting article of footwear may be determined based at least on one or more variables of the pricing algorithm.

In one aspect, receiving the order further comprises retrieving the specifications form a data store that comprise at least one of shoe model options, shoe size options, or embellishment options. The retrieved specifications are rendered within an order interface. Selections indicated by the customer that are directed toward one or more of the specifications are received within the order interface.

In one aspect, receiving the order further comprises presenting a representation of the article of footwear in a display area. A representation of the one or more embellishments in also presented the display area. The representation of the one or more embellishments is translated to overlay a targeted portion of the representation of the article of footwear. A rotational orientation of the representation of the one or more embellishments is adjusted. A relief height of the one or more embellishments is adjusted. The representation of one or more embellishments is resized according to an area associated with the targeted portion.

In one aspect, the embellishment options comprise at least one of design, shape, size, color, and relief height. In one aspect, the one or more embellishments comprise customizations, predetermined designs, functional patterns, or any combination thereof. In one aspect, the functional patterns comprise fit enhancing, breathable, strengthening, and wear-resistant designs. Once received, the computing device converts the specifications of the order into RM instructions, as depicted at step 1620.

In one aspect, converting the specifications of the order into RM instructions comprises deriving the RM instructions, in part, from the translated, adjusted, and resized representation of the one or more embellishments such that, upon the RM device executing the RM instructions, the RM device manufactures the digitally driven creation of solid form footwear components that resemble the translated, adjusted, and resized representation of the one or more embellishments. In one aspect the solid forms are created from powders (e.g., powder sintered). In another aspect, the solid forms are created from liquid resin baths.

The RM instructions are communicated to an RM device at step 1630. The RM instructions are executed, at step 1640, by the RM device to manufacture the one or more embellishments. At step 1650, the one or more embellishments are applied to the article of footwear.

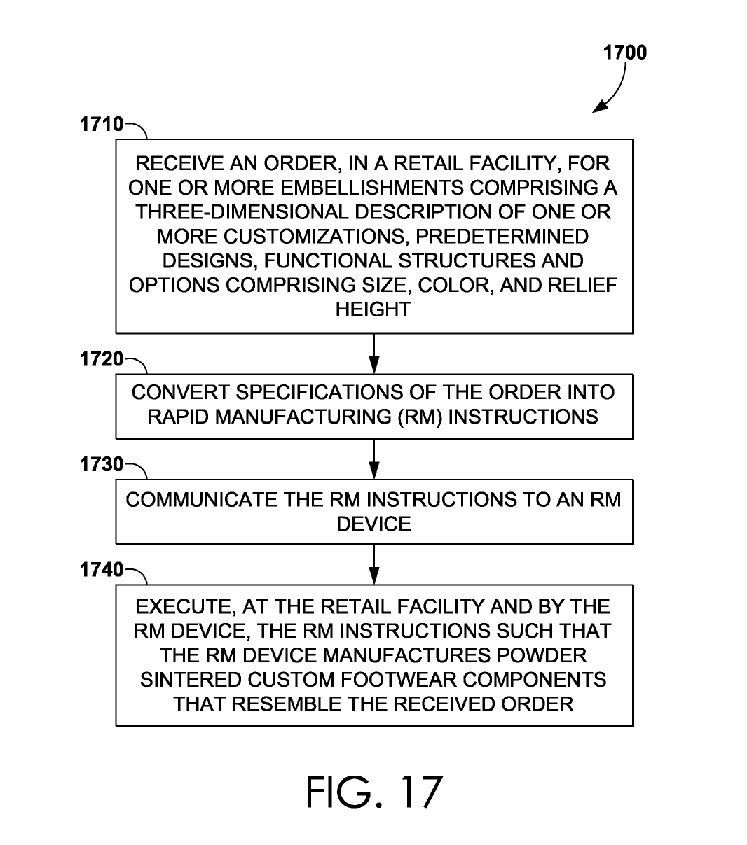

Referring now to FIG. 17, a flow diagram is illustrated that shows an overall method 1700 for incorporating custom footwear components into articles of footwear, in accordance with aspects of the present invention. Initially, as indicated at step 1710, an order for one or more embellishments is received in a retail facility. The one or more embellishments comprise customizations, predetermined designs, functional patterns, or any combination thereof. The one or more embellishments also include embellishment options comprising at least one of design, shape, size, color, relief height, and reflective symmetry. The reflective symmetry or “handedness” accommodates a particular side (e.g., lateral, medial) of an article of footwear, as well as the right or left foot. At step 1720, specifications of the order are converted into RM instructions. The RM instructions are communicated, at step 1730, to an RM device. At step 1740, the RM instructions are executed by the RM device at the retail facility. Upon execution, the RM device manufactures powder sintered custom footwear components that resemble the order.

The present invention has been described in relation to particular aspects, which are intended in all respects to be illustrative rather than restrictive. Alternative aspects will become apparent to those of ordinary skill in the art to which the present invention pertains without departing from its scope. For instance, it should be understood and appreciated that aspects of the present invention are not limited to articles of footwear, and that any piece of apparel or equipment may be utilized in the customization processes described above.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The invention claimed is:

1. A system for manufacturing a custom footwear component in a retail facility, the system comprising:
an input device configured to receive an order for the custom footwear component comprising one or more embellishments selected by a customer;
a computing device configured to receive the order from the input device and convert the order into rapid manufacturing (RM) instructions; and
an RM device in communication with the computing device and configured to receive the RM instructions from the computing device and manufacture the one or more embellishments.

2. The system of claim 1, wherein the input device includes a scanning device, a tablet device, a remote client device, or a computer-storage media.

3. The system of claim 1, further comprising an application device for applying the one or more embellishments to a location on an article of footwear.

4. The system of claim 3, wherein applying comprises pressing, heat welding, radio frequency welding, sonic welding, inserting, gluing, or computer stitching the one or more embellishments to the location on the article of footwear.

5. The system of claim 4, wherein the location is a predetermined location designed to receive the one or more embellishments.

6. The system of claim 1, wherein the one or more embellishments comprise patches, inserts, decorative components, name tags, logos, dates, pouches, lace holders, snap fittings, mounts for accessories, or any combination thereof.

7. The system of claim 1, wherein the one or more embellishments comprise customizations, predetermined designs, functional patterns, or any combination thereof.

8. The system of claim 1, wherein the order is customized to fit a particular shoe size.

9. The system of claim 1, wherein the order includes patterns, graphics, and coloration for the one or more embellishments.

10. The system of claim 7, wherein the functional patterns comprises fit enhancing, breathable, strengthening, and wear-resistant designs.

11. The system of claim 1, wherein the one or more embellishments are scaled on demand, requiring no molds or parts inventory.

12. The system of claim 1, wherein the one or more embellishments include an attachment flange or mechanism or fitting designed to interface with a receptacle on an article of footwear.

13. A method of incorporating a customized footwear component comprising one or more embellishments into an article of footwear, the method of customizing comprising:
receiving an order at an order interface rendered by a computing device, the order including specifications that pertain to the one or more embellishments;
converting the specifications of the order into rapid manufacturing (RM) instructions;
communicating the RM instructions to a RM device;
executing, by the RM device, the RM instructions to manufacture the one or more embellishments; and
applying the one or more embellishments to the article of footwear.

14. The method of claim 13, wherein the one or more embellishments comprise a three-dimensional description of one or more customizations, predetermined designs, and functional patterns.

15. The method of claim 14, wherein the order interface is linked to a customer-facing pricing algorithm that accounts for a number of parts in the order to be applied to the article of footwear and based upon data comprising at least one of part size, build time, complexity relief height, and location of attachment.

16. The method of claim 13, wherein receiving the order further comprises:
retrieving the specifications from a data store that comprise shoe model options, shoe size options, and embellishment options;
rendering the retrieved specifications within an order interface; and
receiving selections indicated by a customer that are directed toward one or more of the specifications.

17. The method of claim 16, wherein the embellishment options comprise at least one of size, color, relief height, and reflective symmetry.

18. The method of claim 13, wherein receiving the order further comprises:
presenting a representation of the article of footwear in a display area;
presenting a representation of the one or more embellishments in the display area;
translating the representation of the one or more embellishments to overlay a targeted portion of the representation of the article of footwear;
adjusting a rotational orientation of the representation of the one or more embellishments;
adjusting a relief height of the one or more embellishments; and
resizing the representation of one or more embellishments and adjusting reflective symmetry according to an area associated with the targeted portion.

19. The method of claim 18, wherein converting the specifications of the order into the RM instructions comprises deriving the RM instructions, in part, from the translated, adjusted, and resized representation of the one or more embellishments such that, upon the RM device executing the RM instructions, the RM device manufactures solid form footwear components that resemble the translated, adjusted, and resized representation of the one or more embellishments.

20. A method of manufacturing custom footwear components comprising:
receiving an order, in a retail facility, for one or more embellishments comprising a three-dimensional description of one or more customizations, predetermined designs, functional patterns and embellishment options comprising at least one of size, color, and relief height;
converting specifications of the order into rapid manufacturing (RM) instructions;
communicating the RM instructions to an RM device;
executing, at the retail facility and by the RM device, the RM instructions such that the RM device manufactures digitally driven creation of solid form footwear components that resemble the received order.
